(19) United States
(12) Patent Application Publication
(10) Pub. No.: US 2023/0368275 A1
(43) Pub. Date: Nov. 16, 2023

(54) METHOD AND SYSTEM FOR PREVENTING DUPLICATE ORDERS WITHIN A CLIENT-SERVER ARCHITECTURE

(71) Applicant: Volvo Car Corporation, Göteberg (SE)

(72) Inventors: Qirui LI, San Jose, CA (US); Douglas Robert Case, Saratoga, CA (US)

(21) Appl. No.: 18/144,896

(22) Filed: May 9, 2023

Related U.S. Application Data
(60) Provisional application No. 63/340,227, filed on May 10, 2022.

(51) Int. Cl. G06Q 30/0601

(52) U.S. Cl. CPC G06Q 30/0637

(57) ABSTRACT

A method and system for preventing duplicate orders in a client-server architecture, the method including and the system operable for: storing in a database an indicator that an order has been placed for an order identification; when a front-end system calls a back-end system to place a subsequent order for another order identification, the back-end system checking the database to see if the another order identification matches the order identification for the placed order using the indicator; and, if so, the back-end system labeling the subsequent order as a duplicate order and disregarding the subsequent order, but returning a successful return code to the front-end system. The indicator that the order has been placed for the order identification is only stored in the database for a dynamically adjustable threshold period of time, after which period of time the subsequent order is determined to be a new order that is processed.

### CROSS-REFERENCE TO RELATED APPLICATION

The present disclosure claims the benefit of priority of co-pending U.S. Provisional Patent Application No. 63/340,227, filed on May 10, 2022, and entitled “METHOD AND SYSTEM FOR PREVENTING DUPLICATE ORDERS WITHIN A CLIENT-SERVER ARCHITECTURE,” the contents of which are incorporated in full by reference herein.

### TECHNICAL FIELD

The present disclosure relates generally to the automotive sales and vehicle subscription fields. More particularly, the present disclosure relates to a method and system for preventing duplicate orders within a client-server architecture.

### BACKGROUND

Various cloud-based, web browser-based applications exist that allow users in multiple countries to buy or subscribe to vehicles, for example. A subscription, in this case, is a very flexible form of a lease. Such web applications are popular and are used by thousands of customers. However, it is often difficult in a web browser-based application, with a back-end service connecting to another system, to give the web browser user a pleasant user experience and prevent occasional duplicate orders, which can be annoying and costly.

The present background is provided as illustrative environmental context only and should not be construed to be limiting in any manner. The principles and concepts of the present disclosure may be implemented in other contexts equally, without limitation.

### SUMMARY

The present disclosure generally provides a method and system for preventing duplicate orders within a client-server architecture, while maintaining a pleasant user experience. A primary implementation contemplated herein is a vehicle subscription implementation.

In one illustrative embodiment, the present disclosure provides a method for preventing duplicate orders in a client-server architecture, the method including: storing in a database an indicator that an order has been placed for an order identification; when a front-end system calls a back-end system to place a subsequent order for another order identification, the back-end system checking the database to see if the another order identification matches the order identification for the placed order using the indicator; and, if so, the back-end system labeling the subsequent order as a duplicate order and disregarding the subsequent order, but returning a successful return code to the front-end system; where the indicator that the order has been placed for the order identification is only stored in the database for a dynamically adjustable threshold period of time, after which period of time the subsequent order is determined to be a new order that is processed.

In another illustrative embodiment, the present disclosure provides a system for preventing duplicate orders in a client-server architecture, the system including: a database residing in a memory and storing an indicator that an order has been placed for an order identification; and a front-end system in communication with a back-end system, where, when the front-end system calls the back-end system to place a subsequent order for another order identification, the back-end system checks the database to see if the another order identification matches the order identification for the placed order using the indicator, and, if so, the back-end system labels the subsequent order as a duplicate order and disregards the subsequent order, but returns a successful return code to the front-end system; where the indicator that the order has been placed for the order identification is only stored in the database for a dynamically adjustable threshold period of time, after which period of time the subsequent order is determined to be a new order that is processed.

In a further illustrative embodiment, the present disclosure provides a non-transitory computer-readable medium including a memory storing instructions executed by a processor for carrying out steps for preventing duplicate orders in a client-server architecture, the steps including: storing in a database an indicator that an order has been placed for an order identification; when a front-end system calls a back-end system to place a subsequent order for another order identification, the back-end system checking the database to see if the another order identification matches the order identification for the placed order using the indicator; and, if so, the back-end system labeling the subsequent order as a duplicate order and disregarding the subsequent order, but returning a successful return code to the front-end system; where the indicator that the order has been placed for the order identification is only stored in the database for a dynamically adjustable threshold period of time, after which period of time the subsequent order is determined to be a new order that is processed.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic diagram illustrating one embodiment of the system for preventing duplicate orders within a client-server architecture of the present disclosure;

FIG. 2 is a flowchart illustrating one embodiment of the method for preventing duplicate orders within a client-server architecture of the present disclosure;

FIG. 3 is a network diagram of a cloud-based environment for implementing various cloud-based services of the present disclosure;

FIG. 4 is a block diagram of a server that may be used stand-alone, in a networked environment, or in the cloud-based system of FIG. 3; and

FIG. 5 is a block diagram of a user device that may be used in a connected environment or the cloud-based system of FIG. 3.

It will be readily apparent to those of ordinary skill in the art that aspects of all embodiments disclosed herein may be included, omitted, and/or combined as appropriate for a desired application, without limitation.

### DETAILED DESCRIPTION

Again, the present disclosure generally provides a method and system for preventing duplicate orders within a client-server architecture, while maintaining a pleasant user experience. A primary implementation contemplated herein is a vehicle subscription implementation.

In a vehicle subscription transaction, for example, the risk part of the flow is where customers submit their risk-related information for a credit check and bank check to determine if the customers have good enough credit to warrant giving them a subscription. In this step, the users submit not only their name, address, etc., but also information to enable a vehicle manufacturer to ascertain their creditworthiness, including things like bank account information, salary, occupation, debt, expenses, etc. This involves the user submitting this information through the “front-end” code in a web browser. The code within the front-end browser sends the data via an application programming interface (API) to a “back-end” micro-service hosted in the cloud. This back-end micro-service code then sends the information via an API to a third-party API that performs the risk assessment (i.e., credit check) and then asynchronously calls a different API in the back-end micro-service code with the response or result. The front-end code keeps calling the back-end code by API, asynchronously, to get the status.

This has been implemented in the vehicle subscription context and there are occasionally problems with “duplicate orders” (technically duplicate submissions). This means that one vehicle is requested (i.e., one order), but multiple transactions (i.e., multiple records) result, which is a problem. This happens due to inherent design flaws or bugs related to timing issues between the three systems: the web browser, the back-end code, and the API call to the third-party system. As is often the case, a “spinner” is presented to the user in the web browser user interface (UI) to tell the user to be patient while some relatively long-running process is taking place. In the usual case where things succeed, the user is then presented with an order status page in the UI to show the user their status of the order.

The potential problem is that there are two asynchronous systems here. The front-end calls the back-end, asynchronously, and then the back-end calls the third-party API, which is synchronous. This can take a while, so every 2 seconds the front-end UI calls the back-end code to prevent the front-end UI from timing out, and to enable the front-end to keep the spinner spinning to prevent the user from feeling like nothing is happening, which might result in the user refreshing the page, which can cause a duplicate order. When the front-end calls the back-end, the back-end gives a 200 (success) return code response, which tells the front-end that everything is fine so it keeps the spinner going. But despite the spinner, the user can still refresh the whole browser, which can cause different types of problems. The user might in some cases lose the progress or state/status that they have achieved so far. Or, at times, this can cause a duplicate submission. The back-end system usually successfully keeps track of the state/status for the order based on the order identification (ID). If a duplicate submission comes in with the same order ID of an order that has recently been received by the back-end process running in the micro-service, then the subsequent order request is ignored. But occasionally the back-end code within the micro-service can lose the state information. This can happen in multiple ways. One way this can happen is if the micro-service is restarted either on purpose or due to an error of some kind. In this case, a duplicate order can occur since the status/status is lost and the order for that order ID may have recently been sent to the third-party API, but when the next API call request comes to the back-end from the front-end after the front-end user refreshes, the browser the status has been lost so another (duplicate) call to the third-party API is made resulting in a duplicate order.

The solution is for the back-end to store in a non-volatile database system the indicator that an order has been placed for a specific order ID. Anytime the front-end calls the back-end to place an order for a certain order ID, the back-end first checks the database to see if an order was recently placed for the order ID. If so, it assumes that this is a duplicate order and the request is ignored—but it still sends back a successful (200) return code to the front-end. It is key that “duplicate” orders are only ignored/rejected/not processed for recent orders. There are two key threshold values here, the lower threshold value and the upper threshold value. 30 seconds may be used for the lower threshold value and 40 seconds for the upper threshold value. These can vary and be dynamically adjusted based on a variety of factors. The database stores the order ID that was processed—in this case sent to the third-party API. Associated with that ID there is a ttl (time to live) or an expiration time. In this case it is 40 seconds after it is created—the higher threshold value. The database entry is removed/deleted after the second threshold is met. This makes it easier in the future to see if a new incoming order is a duplicate or not, based on the order ID.

The assumption is that if the back-end is called twice in a time period with the same order ID less than the first/lower threshold, then it is a duplicate order and it should be ignored. The assumption is that if the back-end is called again with the same order ID more than the second/higher threshold after the first call, then it is a valid order, possibly an updated order or an additional valid order, and that order should be allowed to be placed. A key part of this is how to pick good first and second threshold values.

This can be generalized to not just include calling a third-party API, but for any process/task/behavior that is desired to only happen once within a time period, but is not desired to happen multiple times by accident. This can be done such that the process/task/behavior can be done again later if a sufficient amount of time has passed.

There can be dynamic altering for either/both threshold values (30 seconds and/or 40 seconds) based on various values (network latency, frequency of UI refreshes, system load, knowledge of user behavior or frequency of micro-service restarts, and/or how long micro-service restarts take, and/or artificial intelligence (AI) or learned behavior of a specific user of class of users).

This general technique/algorithm/system can be generalized in multiple ways. It need not apply specifically to calling a third-party API.

This general technique/algorithm/system can also be generalized to not be specific to a user refreshing a browser, but can apply to any situation where there can be “duplicate” API requests coming in within a short period of time to a service, including a back-end micro-service.

This general technique/algorithm/system can also be generalized to not be specific to a back-end micro-service. This technique could apply to any volatile system that can create some non-volatile storage, such as a database.

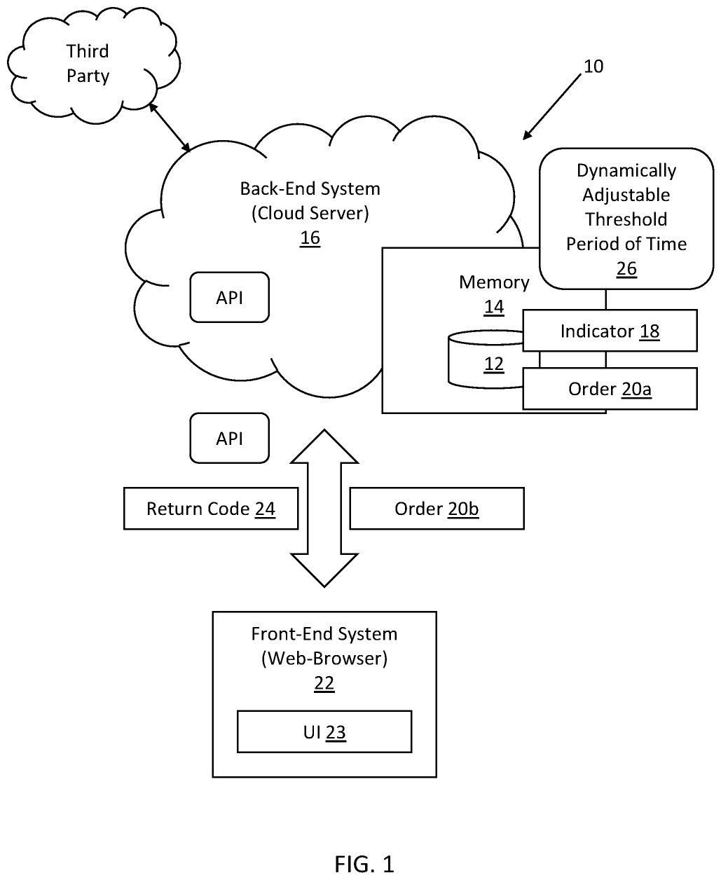

Referring now specifically to FIG. 1, the system 10 for preventing duplicate orders in a client-server architecture includes a database 12 residing in a memory 14 in a back-end system 16, such as a cloud server, and storing an indicator 18 that an order has been placed for an order identification 20a. The system 10 also includes a front-end system 22 including a user interface (UI) 23 in communication with the back-end system 16, where, when the front-end system 22 calls the back-end system 16 to place a subsequent order for another order identification 20b, the back-end system 16 checks the database 12 to see if the another order identification 20b matches the order identification 20a for the placed order using the indicator 18. If so, the back-end system 16 labels the subsequent order 20b as a duplicate order and disregards the subsequent order 20b, but returns a successful return code 24 to the front-end system 22. The indicator 18 that the order has been placed for the order identification 20a is only stored in the database 12 for a dynamically adjustable threshold period of time 26, after which period of time 26 the subsequent order 20b is determined to be a new order that is processed.

Again, the front-end calls the back-end, asynchronously, and then the back-end calls the third-party API, which is synchronous. This can take a while, so every 2 seconds the front-end UI calls the back-end code to prevent the front-end UI from timing out, and to enable the front-end to keep the spinner spinning to prevent the user from feeling like nothing is happening, which might result in the user refreshing the page, which can cause a duplicate order. When the front-end calls the back-end, the back-end gives a 200 (success) return code response, which tells the front-end that everything is fine so it keeps the spinner going. But despite the spinner, the user can still refresh the whole browser, which can cause different types of problems. The user might in some cases lose the progress or state/status that they have achieved so far. Or, at times, this can cause a duplicate submission. The back-end system usually successfully keeps track of the state/status for the order based on the order identification (ID). If a duplicate submission comes in with the same order ID of an order that has recently been received by the back-end process running in the micro-service, then the subsequent order request is ignored. But occasionally the back-end code within the micro-service can lose the state information. This can happen in multiple ways. One way this can happen is if the micro-service is restarted either on purpose or due to an error of some kind. In this case, a duplicate order can occur since the status/status is lost and the order for that order ID may have recently been sent to the third-party API, but when the next API call request comes to the back-end from the front-end after the front-end user refreshes, the browser the status has been lost so another (duplicate) call to the third-party API is made resulting in a duplicate order.

The solution is for the back-end to store in a non-volatile database system the indicator that an order has been placed for a specific order ID. Anytime the front-end calls the back-end to place an order for a certain order ID, the back-end first checks the database to see if an order was recently placed for the order ID. If so, it assumes that this is a duplicate order and the request is ignored—but it still sends back a successful (200) return code to the front-end. It is key that “duplicate” orders are only ignored/rejected/not processed for recent orders. There are two key threshold values here, the lower threshold value and the upper threshold value. 30 seconds may be used for the lower threshold value and 40 seconds for the upper threshold value. These can vary and be dynamically adjusted based on a variety of factors. The database stores the order ID that was processed—in this case sent to the third-party API. Associated with that ID there is a ttl (time to live) or an expiration time. In this case it is 40 seconds after it is created—the higher threshold value. The database entry is removed/deleted after the second threshold is met. This makes it easier in the future to see if a new incoming order is a duplicate or not, based on the order ID.

The assumption is that if the back-end is called twice in a time period with the same order ID less than the first/lower threshold, then it is a duplicate order and it should be ignored. The assumption is that if the back-end is called again with the same order ID more than the second/higher threshold after the first call, then it is a valid order, possibly an updated order or an additional valid order, and that order should be allowed to be placed. A key part of this is how to pick good first and second threshold values.

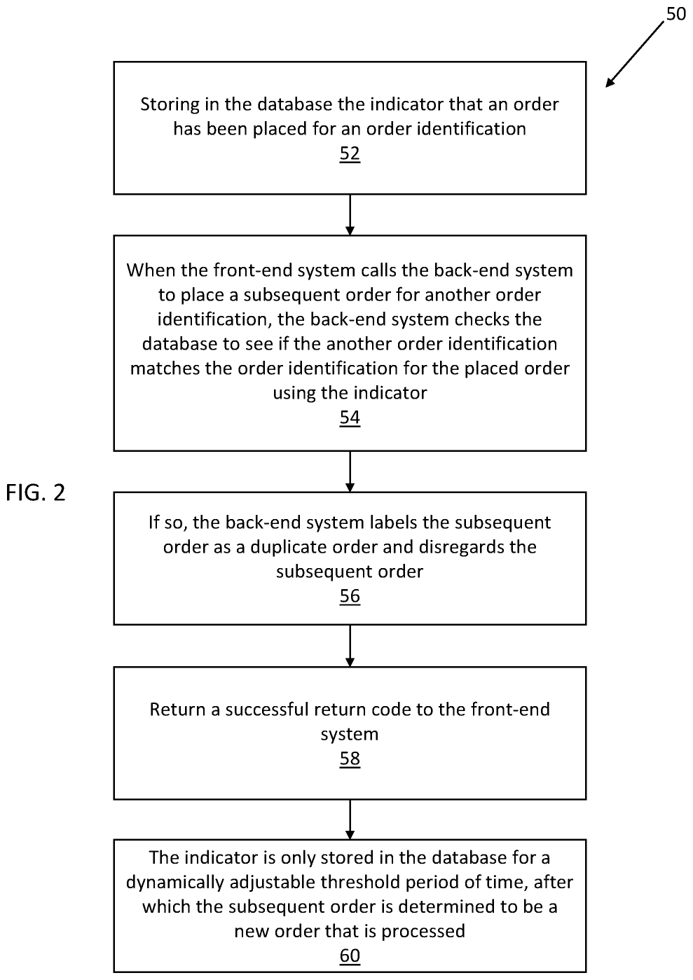

Referring now specifically to FIG. 2, the method 50 for preventing duplicate orders in a client-server architecture includes storing in the database the indicator that an order has been placed for an order identification (step 52). When the front-end system calls the back-end system to place a subsequent order for another order identification, the back-end system checks the database to see if the another order identification matches the order identification for the placed order using the indicator (step 54). If so, the back-end system labels the subsequent order as a duplicate order and disregards the subsequent order (step 56), but returns a successful return code to the front-end system (step 58). The indicator that the order has been placed for the order identification is only stored in the database for a dynamically adjustable threshold period of time, after which period of time the subsequent order is determined to be a new order that is processed (step 60).

Again, the front-end calls the back-end, asynchronously, and then the back-end calls the third-party API, which is synchronous. This can take a while, so every 2 seconds the front-end UI calls the back-end code to prevent the front-end UI from timing out, and to enable the front-end to keep the spinner spinning to prevent the user from feeling like nothing is happening, which might result in the user refreshing the page, which can cause a duplicate order. When the front-end calls the back-end, the back-end gives a 200 (success) return code response, which tells the front-end that everything is fine so it keeps the spinner going. But despite the spinner, the user can still refresh the whole browser, which can cause different types of problems. The user might in some cases lose the progress or state/status that they have achieved so far. Or, at times, this can cause a duplicate submission. The back-end system usually successfully keeps track of the state/status for the order based on the order identification (ID). If a duplicate submission comes in with the same order ID of an order that has recently been received by the back-end process running in the micro-service, then the subsequent order request is ignored. But occasionally the back-end code within the micro-service can lose the state information. This can happen in multiple ways. One way this can happen is if the micro-service is restarted either on purpose or due to an error of some kind. In this case, a duplicate order can occur since the status/status is lost and the order for that order ID may have recently been sent to the third-party API, but when the next API call request comes to the back-end from the front-end after the front-end user refreshes, the browser the status has been lost so another (duplicate) call to the third-party API is made resulting in a duplicate order.

The solution is for the back-end to store in a non-volatile database system the indicator that an order has been placed for a specific order ID. Anytime the front-end calls the back-end to place an order for a certain order ID, the back-end first checks the database to see if an order was recently placed for the order ID. If so, it assumes that this is a duplicate order and the request is ignored—but it still sends back a successful (200) return code to the front-end. It is key that “duplicate” orders are only ignored/rejected/not processed for recent orders. There are two key threshold values here, the lower threshold value and the upper threshold value. 30 seconds may be used for the lower threshold value and 40 seconds for the upper threshold value. These can vary and be dynamically adjusted based on a variety of factors. The database stores the order ID that was processed—in this case sent to the third-party API. Associated with that ID there is a ttl (time to live) or an expiration time. In this case it is 40 seconds after it is created—the higher threshold value. The database entry is removed/deleted after the second threshold is met. This makes it easier in the future to see if a new incoming order is a duplicate or not, based on the order ID.

The assumption is that if the back-end is called twice in a time period with the same order ID less than the first/lower threshold, then it is a duplicate order and it should be ignored. The assumption is that if the back-end is called again with the same order ID more than the second/higher threshold after the first call, then it is a valid order, possibly an updated order or an additional valid order, and that order should be allowed to be placed. A key part of this is how to pick good first and second threshold values.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

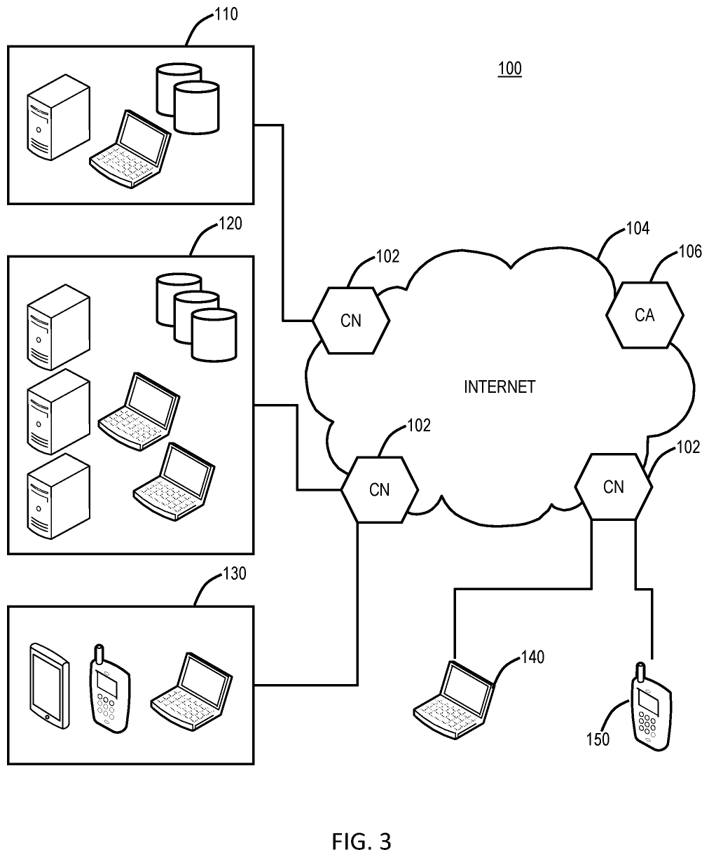

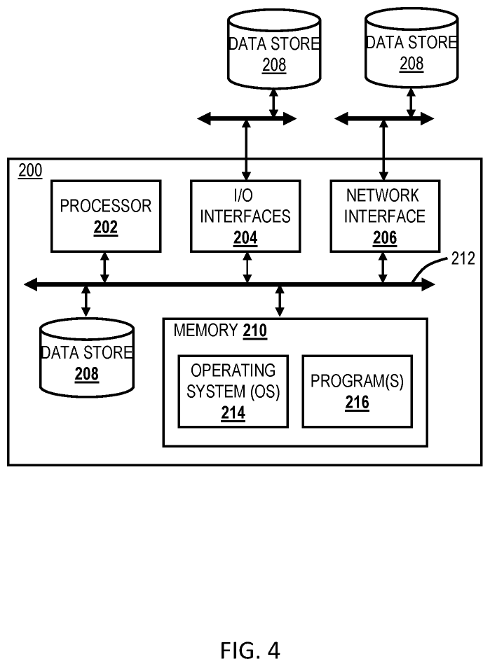

FIG. 3 is a network diagram of a cloud-based system 100 for implementing various cloud-based services of the present disclosure. The cloud-based system 100 includes one or more cloud nodes (CNs) 102 communicatively coupled to the Internet 104 or the like. The cloud nodes 102 may be implemented as a server 200 (as illustrated in FIG. 4) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various employee's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

The cloud-based system 100 can provide any functionality through services such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application necessarily required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 4 is a block diagram of a server 200, which may be used in the cloud-based system 100 (FIG. 3), in other networked systems, or stand-alone. For example, the CNs 102 (FIG. 3) and the central authority nodes 106 (FIG. 3) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 3). The network interface 206 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

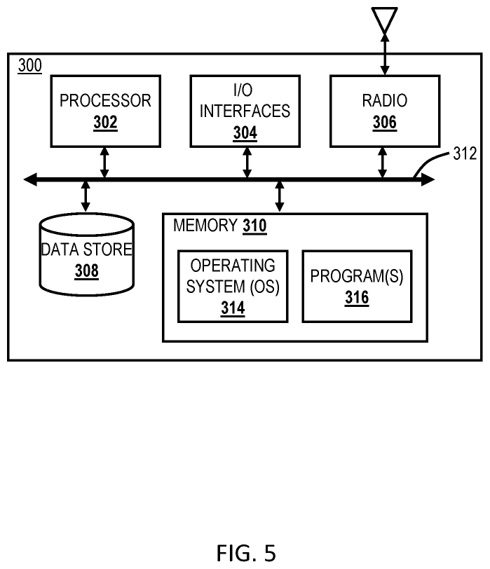

FIG. 5 is a block diagram of a user device 300, which may be used in the cloud-based system 100 (FIG. 3) or the like. Again, the user device 300 can be a smartphone, a tablet, a smartwatch, an Internet of Things (IoT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 5 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 5, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100 (FIG. 3).

Although the present disclosure is illustrated and described herein with reference to illustrative embodiments and specific examples thereof, it will be readily apparent to those of ordinary skill in the art that other illustrative embodiments and examples may perform similar functions and/or achieve like results. All such equivalent illustrative embodiments and examples are within the spirit and scope of the present disclosure, are contemplated thereby, and are intended to be covered by the following non-limiting claims for all purposes.

What is claimed is:

1. A method for preventing duplicate orders in a client-server architecture, the method comprising:
storing in a database an indicator that an order has been placed for an order identification;
when a front-end system calls a back-end system to place a subsequent order for another order identification, the back-end system checking the database to see if the another order identification matches the order identification for the placed order using the indicator; and
if so, the back-end system labeling the subsequent order as a duplicate order and disregarding the subsequent order, but returning a successful return code to the front-end system;
wherein the indicator that the order has been placed for the order identification is only stored in the database for a dynamically adjustable threshold period of time, after which period of time the subsequent order is determined to be a new order that is processed.

2. The method of claim 1, wherein the order and the subsequent order are for a vehicle subscription.

3. The method of claim 1, wherein the front-end system comprises a web interface.

4. The method of claim 1, wherein the back-end system comprises a cloud server.

5. The method of claim 1, wherein the period of time comprises a lower threshold value and an upper threshold value.

6. The method of claim 5, wherein the lower threshold is 30 seconds and the upper threshold is 40 seconds.

7. The method of claim 1, wherein the period of time is dynamically adjusted based on one or more of: network latency, frequency of user interface (UI) refreshes, system load, knowledge of user behavior or frequency of micro-service restarts, how long micro-service restarts take, and artificial intelligence (AI) or learned behavior of a specific user of a class of users.

8. A system for preventing duplicate orders in a client-server architecture, the system comprising:
a database residing in a memory and storing an indicator that an order has been placed for an order identification; and
a front-end system in communication with a back-end system, wherein, when the front-end system calls the back-end system to place a subsequent order for another order identification, the back-end system checks the database to see if the another order identification matches the order identification for the placed order using the indicator, and, if so, the back-end system labels the subsequent order as a duplicate order and disregards the subsequent order, but returns a successful return code to the front-end system;
wherein the indicator that the order has been placed for the order identification is only stored in the database for a dynamically adjustable threshold period of time, after which period of time the subsequent order is determined to be a new order that is processed.

9. The system of claim 8, wherein the order and the subsequent order are for a vehicle subscription.

10. The system of claim 8, wherein the front-end system comprises a web interface.

11. The system of claim 8, wherein the back-end system comprises a cloud server.

12. The system of claim 8, wherein the period of time comprises a lower threshold value and an upper threshold value.

13. The system of claim 12, wherein the lower threshold is 30 seconds and the upper threshold is 40 seconds.

14. The system of claim 8, wherein the period of time is dynamically adjusted based on one or more of: network latency, frequency of user interface (UI) refreshes, system load, knowledge of user behavior or frequency of micro-service restarts, how long micro-service restarts take, and artificial intelligence (AI) or learned behavior of a specific user of a class of users.

15. A non-transitory computer-readable medium comprising a memory storing instructions executed by a processor for carrying out steps for preventing duplicate orders in a client-server architecture, the steps comprising:
storing in a database an indicator that an order has been placed for an order identification;
when a front-end system calls a back-end system to place a subsequent order for another order identification, the back-end system checking the database to see if the another order identification matches the order identification for the placed order using the indicator; and
if so, the back-end system labeling the subsequent order as a duplicate order and disregarding the subsequent order, but returning a successful return code to the front-end system;
wherein the indicator that the order has been placed for the order identification is only stored in the database for a dynamically adjustable threshold period of time, after which period of time the subsequent order is determined to be a new order that is processed.

16. The non-transitory computer-readable medium of claim 15, wherein the order and the subsequent order are for a vehicle subscription.

17. The non-transitory computer-readable medium of claim 15, wherein the front-end system comprises a web interface.

18. The non-transitory computer-readable medium of claim 15, wherein the back-end system comprises a cloud server.

19. The non-transitory computer-readable medium of claim 15, wherein the period of time comprises a lower threshold value and an upper threshold value.

20. The non-transitory computer-readable medium of claim 15, wherein the period of time is dynamically adjusted based on one or more of: network latency, frequency of user interface (UI) refreshes, system load, knowledge of user behavior or frequency of micro-service restarts, how long micro-service restarts take, and artificial intelligence (AI) or learned behavior of a specific user of a class of users.
